(19) United States
(12) Patent Application Publication
(10) Pub. No.: US 2013/0295857 A1
(43) Pub. Date: Nov. 7, 2013

(54) OVER-THE-AIR TEST

(71) Applicants: Jukka-Pekka Nuutinen, Martinniemi (FI); Pekka Kyosti, Jokirinne (FI)

(72) Inventors: Jukka-Pekka Nuutinen, Martinniemi (FI); Pekka Kyosti, Jokirinne (FI)

(21) Appl. No.: 13/997,953

(22) PCT Filed: Dec. 28, 2010
(86) PCT No.: PCT/FI2010/051092

§ 371 Date: Jun. 25, 2013

(51) Int. Cl. H04B 17/00

(52) U.S. Cl. CPC H04B 17/009
USPC 455/67.12

(57) ABSTRACT

A preselector forms a plurality of preselections, by generating, for each preselection, a predetermined number of random locations, each location being for an antenna element of the predetermined number of antenna elements around a device under test in an over-the-air test. A selector selects, for at least one path of a radio channel to be simulated, a preselection from among the plurality of preselections for which an absolute error between a theoretical and real spatial correlation is below a predetermined threshold. A connector connects the antenna elements at the locations of the selected preselection and the radio channel emulator together for physically realizing the simulated radio channel for the device under test and the radio channel emulator.

### CROSS-REFERENCE TO RELATED APPLICATION

This application is a National Stage application of International Application No. PCT/FI2010/051092, filed Dec. 28, 2010, which is incorporated by reference herein in its entirety.

### BACKGROUND

1. Field

The invention relates to over-the-air testing of a device in an anechoic chamber.

2. Description of the Related Art

When a radio frequency signal is transmitted from a transmitter to a receiver, the signal propagates in a radio channel along one or more paths having different angles of arrivals, signal delays, polarizations and powers, which cause fadings of different durations and strengths in the received signal. In addition, noise and interference due to other transmitters interfere with the radio connection.

A transmitter and a receiver can be tested using a radio channel emulator emulating real circumstances. In a digital radio channel emulator, a radio channel is usually modeled with an FIR filter (Finite Impulse Response). A traditional radio channel emulation test is performed via a conducted connection such that a transmitter and a receiver are coupled together via a cable.

Communication between a subscriber terminal and a base station of a radio system can be tested using an OTA (Over The Air) test, where a real DUT (Device Under Test) is surrounded by a plurality of antenna elements of an emulator in an anechoic chamber. The emulator may be coupled to or act as a base station and emulate paths between the subscriber terminal and the base station according to a channel model. Between each antenna and the emulator there is an antenna-element-specific channel. Often a lot of antenna elements and hence a lot of antenna-element-specific channels are needed. The reason for a high number of antenna elements may be a need for a large enough quiet zone in the test chamber. However, when the number of antenna-element-specific channels increases, the testing system becomes more complicated and expensive. Hence, there is a need for a different approach.

### SUMMARY

The following presents a simplified summary of the invention in order to provide a basic understanding of some aspects of the invention. This summary is not an extensive overview of the invention. It is not intended to identify key elements of the invention or to delineate the scope of the invention. Its sole purpose is to present some concepts of the invention in a simplified form as a prelude to the more detailed description that will be presented below.

An aspect of the invention relates to a apparatus comprising a preselector configured to form a plurality of preselections, by generating, for each preselection, a predetermined number of random locations, each location being for an antenna element of the predetermined number of antenna elements around a device under test in an over-the-air test; a selector configured to select, for at least one path of a radio channel to be simulated, a preselection from among the plurality of preselections for which an absolute error between a theoretical and real spatial correlation is below a predetermined threshold; a connector configured to connect the antenna elements at the locations of the selected preselection and a radio channel emulator together for physically realizing the simulated radio channel for the device under test and the radio channel emulator.

A further aspect of the invention is a method comprising forming a plurality of preselections, by generating, for each preselection, a predetermined number of random locations, each location being for an antenna element of the predetermined number of antenna elements around a device under test in an over-the-air test; selecting, for at least one path of a simulated radio channel, a preselection from among the plurality of a preselections for which an absolute error between a theoretical and real spatial correlation is below a predetermined threshold; connecting the antenna elements at the locations of the selected preselection of the at least one path and a radio channel emulator together for physically realizing the simulated radio channel for the device under test and the radio channel emulator.

A further aspect of the invention is an emulating system of an over-the-air test, the emulating system comprising a radio channel emulator, a plurality of antenna elements, a preselector, a selector, and a connector; the preselector being configured to form a plurality of preselections, by generating, for each preselection, a predetermined number of random locations, each location being for an antenna element of the predetermined number of antenna elements around a device under test in an over-the-air test; the selector being configured to select, for at least one path of a radio channel to be simulated, a preselection from among the plurality of preselections for which an absolute error between a theoretical and real spatial correlation is below a predetermined threshold; the connector being configured to connect the antenna elements at the locations of the selected preselection and the radio channel emulator together for physically realizing the simulated radio channel for the device under test and the radio channel emulator.

Although various aspects, embodiments and features of the invention are recited independently, it should be appreciated that all combinations of the various aspects, embodiments and features of the invention are possible and within the scope of the present invention as claimed.

The invention provides an accurate angular power distribution with a suitable number of antenna-element-specific channels and antenna elements at optimized locations.

### BRIEF DESCRIPTION OF THE DRAWINGS

In the following, the invention will be described in greater detail by means of exemplary embodiments with reference to the attached drawings, in which

FIG. 1 shows a plane geometrical embodiment of an OTA test chamber;

FIG. 2 shows clusters reflecting a signal propagating between a transmitter and a receiver;

FIG. 3 shows a desired power as a function of angle;

FIG. 4 shows a Fourier-transform of PAS;

FIG. 5 shows powers of antenna elements;

FIG. 6 shows a solid geometrical embodiment of an OTA test chamber;

FIG. 7 shows three spatial correlation lines;

FIG. 8 shows three orthogonal segments of lines, and

FIG. 9 shows a flow chart of the method.

### DETAILED DESCRIPTION

Exemplary embodiments of the present invention will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Therefore, all words and expressions should be interpreted broadly and they are intended to illustrate, not to restrict, each embodiment.

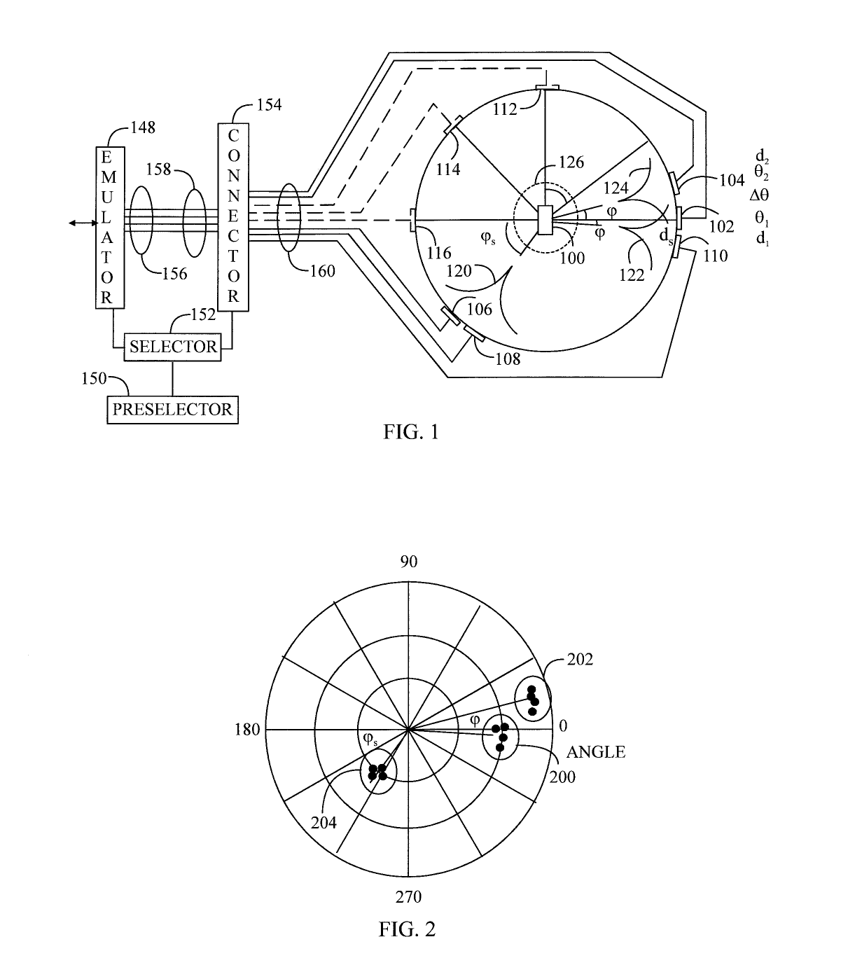

FIG. 1 presents an OTA test chamber in a plane geometrical way. A DUT 100, which may be a subscriber terminal, is in the centre and active antenna elements 102, 104, 106, and 108 are distributed at locations of a preselection generated by a preselector 150. The preselection shown in FIG. 1 has been selected from a plurality of preselections by a selector 152, each preselection having locations which are generated randomly by the preselector 150. There may be more antenna elements 110, 112, 114, and 116 available if more antenna elements are needed.

The locations are at a predetermined distance from the DUT. The locations may be discretely on a circumference around the DUT 100. The DUT 100, in turn, may be in a quiet zone corresponding to a test spot 126. Let us denote the directions of J OTA antenna elements 102 to 108 with respect to the DUT 100 with θₖ, k=1, . . . , J, and spacings d₁, d₂, . . . d_{J} of antenna elements in the angle domain with Δθₖ, where J refers to the number of active antenna elements 102 to 108 at each moment of time. The angle Δθₖ expresses a measure of an angular separation of two antenna elements 102 to 108 with respect to the electronic device 100. Since the places of antenna elements 102 to 108 are randomly chosen, the different spacings d₁, d₂, . . . d_{J} are likely to be different and, similarly, the separation angle Δθₖ is usually different from any other separation angle Δθⱼ, where j≠k.

The antenna elements 102 to 108 are usually at the same distance from the DUT 100, but they may be at different distances from the DUT 100. Correspondingly, the antenna elements 102 to 108 may only be placed in a sector instead of being placed at a full angle or at a full solid angle. The DUT 100 may also have one or more elements in the antenna.

The test chamber may be an anechoic room. An emulator 148 may comprise at least one FIR filter for forming each antenna-specific channel. Additionally or alternatively, the emulator 148 may comprise a processor, a memory, and a suitable computer program for providing the antenna-specific channels.

The emulator 148 has at least one radio channel model, one of which may be selected to be used as a simulated radio channel for a test. The simulated radio channel may be selected by a person carrying out the test. The simulated radio channel used may be a play back model based on a channel recorded from a real radio system or it may be an artificially generated model or it may be a combination of a playback model and an artificially generated model. The at least one radio channel may be stored in the memory of the emulator 148.

Each emulator output port 156 of an emulator 148 such as EB (Elektrobit) Propsim® F8 may be connected to an input 158 port of a connector 154. Similarly, each antenna element 102 to 108 may be connected to an output port 160 of the connector 154. The emulator 148 forms a predetermined number of antenna-element-specific channels of the simulated radio channel.

How the emulator 148 forms the antenna-element-specific channels for the antenna elements 102 to 108 is described more thoroughly in patent application PCT/FI2009/050471.

One antenna-element-specific channel is then associated with one antenna element by a connection between the emulator 148 and the antenna element. In general, at least one antenna element 102 to 108 is coupled to the emulator 148 whenever a path is simulated.

Assume now that a predetermined number of antenna elements 102 to 108 is to be used. The preselector 150 forms a plurality of preselections, each preselection having a predetermined number of random locations. The locations may be defined by an angle θ₁, θ₂, . . . θ_{J} with respect to a predetermined direction or a distance d₁, d₂, . . . d_{J} from a predetermined location on a predefined curve (such as a circumference of a circle) round the DUT 100. Each random location is for a different antenna element 102 to 108. The predetermined number of antenna elements 102 to 108 may be the maximum available, or the number of antenna elements 102 to 108 may be limited to a subset of antenna elements the number of which is less than the maximum available. The limitation of the number of antenna elements 102 to 108 may be based on the radio channel to be simulated or on angular data and angular spread determining the directions of at least one path at each moment. The limitations of the number of antenna elements 102 to 108 is described more thoroughly in patent application PCT/FI2010/050419.

Assume now that antenna elements for one path 120 of a radio channel are needed. The emulating system comprises a selector 152. The emulator 148 provides the selector 152 with data about the simulated radio channel. With the data the selector 152 selects, for the path 120 to be simulated, a preselection from among the plurality of preselections provided by the preselector 150.

When a preselection for one path is selected by the selector 152, preselections for another path may be formed by the preselector 150, and a preselection may be selected from among them by the selector 152. Alternatively, preselections for each of a plurality of paths may be formed by the preselector 150 and a desired preselection may be selected for each of them from the preselections in a similar manner by the selector 152. This is possible since random locations for antenna elements in one or more preselections can be generated irrespective of the number of paths.

The antenna elements 102 to 108 may be continuously movable from one location to another location. This allows the antenna elements to be placed randomly and to have a higher density of antenna elements in a sector where they are needed at a certain moment. The antenna elements may be moved by a motor or pneumatically or hydraulically.

For one or more paths, a connector 154 connects the antenna elements 102 to 108 at the locations of the selected preselection and the radio channel emulator 148 together for physically realizing the simulated radio channel for the DUT 100 and the radio channel emulator 148.

The angles φ of arrivals between the emulator 150 and the device 100 under test usually differ at different moments, since clusters in the simulated situation reflect the signals differently. The term cluster refers to multipath signal components occurring in groups and having similar values of parameters. A cluster can be considered a base for a path. Such multipath components of a radio channel occur due to objects or parts of at least one object which scatter. Clusters are often associated with a MIMO (Multiple-Input and Multiple-Output) channel model but the term may be used in conjunction with other channel modes, too. A cluster may be time variant.

FIG. 2 shows clusters 200, 202, 204 which reflect a signal propagating between a transmitter and a receiver at a certain moment, the reflections defining the angles of arrival of the signal components to the receiver. Clusters in general may have a plurality of active regions (illustrated with black dots in FIG. 2) which cause different delays and powers to the reflected signal components. It can be seen that the angle φ of arrival of the first cluster 200 is about −15°, the angle φ of arrival of the second cluster is about 15° and the angle φ of arrival of the third cluster is about 150°. The angular spread of a cluster is typically 1° to 15° and power distribution of the spread of a cluster may properly be realized by placing antenna elements randomly at the locations inside the spread area.

The data of the simulated radio channel may include information on an angular distribution of direction(s) of reception i.e. directions of paths. The data may give or have coordinates where the DUT 100 is and hence the angular data may be expressed relative to the DUT 100 irrespective of whether the data is received by the DUT 100 or the antenna elements.

When the antenna elements 102 to 108 are used for transmitting a signal through, for example, paths 120 to 124 to the DUT 100, the DUT 100 is the receiver and the data then includes direct or indirect information on angles φ of arrivals with respect to the DUT 100. Note that for the sake of clarity angle φₛ is defined as φₛ=φ+180° in FIG. 1. As an example, two directions of reception of paths 122, 124 have a narrow angular difference and need more antenna elements to realize it than the path 120. Additionally or alternatively, the DUT 100 may transmit to the antenna elements 102 to 108.

The angles φ of arrivals may be the directions of paths 120 to 124 to or from the DUT 100. Hence, the angular distribution of the directions of reception may be considered as angular distribution of the paths 120 to 124 and the distribution may be extracted from the simulated radio channel in the emulator 148 or the emulator 148 may feed the simulated radio channel to the preselector 150 which may then extract the specific data about the angular distribution of the directions of reception for the purposes of the preselection of locations.

FIG. 3 presents graphically a desired power 300 of one cluster as a function of an angle, i.e. a PAS (Power Angular Spectrum) around the DUT 100. Power is shown on the vertical axis and angles are shown on the horizontal axis. In this example, the PAS is Laplacian shaped like it usually is. The peak is at the angle φ of arrival. It may be possible that a location corresponding to the peak of the PAS is generated in all preselections for an antenna element. Then all other locations for other antenna elements in different preselections may be randomly generated. In this way, different preselections are likely to be different, except for the location at the peak.

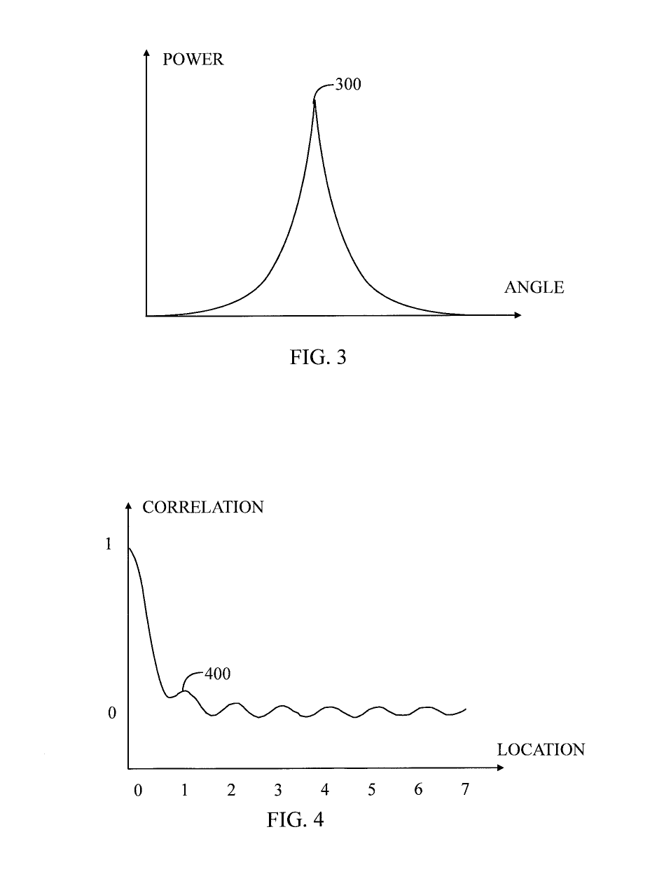

The PAS may be Fourier-transformed, and the result is presented in FIG. 4. The PAS Fourier-transformed PAS results in a spatial correlation function 400. The correlation values are shown on the vertical axis and the location in wavelengths is shown on the horizontal axis.

Now, the selection of a preselection from a plurality of preselections may be performed using spatial correlations which depend on the PASes and hence also on paths. The spatial correlation in the OTA test chamber depends on spatial separations Δₘ of ULA (Uniform Linear Array) antenna elements in the DUT 100, nominal angles of arrival φ, angular spreads σ_{φ} of angles of arrival as arguments. In general, a spatial separation may be defined as a phase distance between two points. Usually the phase distance in the test spot 126 of the quiet zone is taken into account. The phase distance may be obtained by dividing a distance of two points by a wavelength which may further be multiplied by 2π, for example.

Since the places of the antenna elements in the preselection are random, the spatial separations Δₘ are also random.

The selector 152 may find an optimized preselection from the plurality of preselections on the basis of an error function formed like an L²-norm for one or more clusters, for example:

$${E}_{ρ}^{i} = \sqrt{\frac{1}{M} {\sum }_{m = 1}^{M} \vert ρ ( {Δ}_{m} , ϕ , {σ}_{ϕ} ) - \tilde{ρ} ( {Δ}_{m} ) {\vert}^{2}} , \qquad ( 1 )$$

where i refers to an i^{th} preselection, ρ(Δₘ, φ, σ_{φ}) is a theoretical spatial cross correlation, and \tilde{ρ}(Δₘ) is a real spatial correlation obtained with the OTA antenna elements at various randomly selected positions.

The selector 152 searches for an optimized error from the plurality or errors E_{ρ}¹, E_{ρ}², . . . , E_{ρ}^{K} which is at or below a predetermined threshold where the threshold and the errors E_{ρ}¹, E_{ρ}², . . , E_{ρ}^{K} are positive real numbers. In this way, it is possible for the selector 152 to select a desired preselection with an optimized error from among a plurality of preselections.

The theoretical cross correlation function ρ(Δₘ, φ₀, σ_{φ}) for Laplacian shaped PAS (Power Angular Spectrum) may be defined as

$$ρ ( {Δ}_{m} , {ϕ}_{0} , {σ}_{ϕ} ) = \int exp ( - j 2 {πΔ}_{m} sin ( {ϕ}_{0} + ϕ ) ) \frac{1}{\sqrt{2} {σ}_{ϕ}} exp ( \frac{\sqrt{2} \vert ϕ \vert}{{σ}_{ϕ}} ) d ϕ . \qquad ( 2 )$$

In practice, it can be calculated for truncated Laplacian PAS or by discrete approximation. The spatial correlation obtained with the OTA antenna elements may be defined as

$$\tilde{ρ} ( {Δ}_{m} , {θ}_{0} ) = {( {\sum }_{i = 1}^{J} {g}_{{k}_{i}} )}^{- 1} {\sum }_{k = 1}^{J} {g}_{{k}_{i}} exp ( - j 2 {πΔ}_{m} sin {θ}_{{k}_{i}} ) , \qquad ( 3 )$$

where the term J represents the number of active antenna elements in the iteration and gₖ may be limited such that gₖ⊂[0,1]. The weights gₖ can be obtained from the PAS and they may be represented in a vector form:

G=(g₁, g₂, . . . , g_{J}). (4)

The equation (1) may be computed by applying (2) and (3) and using numerical optimization methods, such as a gradient method or a half space method or the like.

Then the error E_{ρ} is similarly solved for all other paths (i.e. clusters) if there is more than one path (cluster). After obtaining all errors E_{ρ} associated with the different preselections, a preselection having the smallest error or an optimized error may selected from the plurality of preselections.

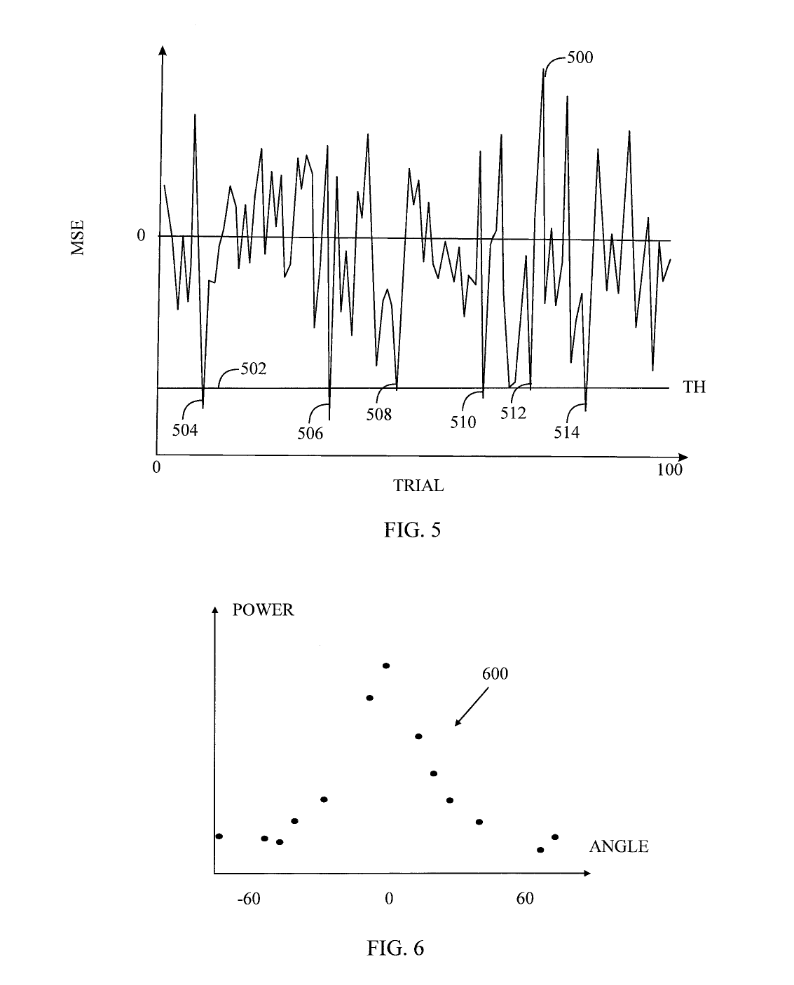

FIG. 5 presents a value (vertical axis) of an error E_{ρ}500 as a function of preselections (horizontal axis). Different preselections result in different errors E_{ρ} in the selector 152. The selector 152 selects a preselection for which an absolute error between a theoretical and real spatial correlation is at or below a predetermined threshold 502. The threshold may be the minimum absolute error (not in FIG. 5) or a desired value above it, as in FIG. 5. If there are (potentially) many preselections 504, 506, 508, 510, 512 and 514 whose absolute error is below the predetermined threshold 502, the one 504 which is found first may be selected, for example. However, the selection is not restricted to that and it may be performed according to other criteria, too.

FIG. 6 presents powers 600 of the antenna elements placed randomly according to preselection 506 around the DUT 100, for instance. It can also be considered that the distribution in FIG. 6 presents weights G for each available antenna element. The discrete distribution represents an inverse-transformed form of the spatial correlation function presented in FIG. 4 after the selection on the basis of the optimization in the selector 152. It can be seen that the spacing of antenna elements is random i.e. the black dots have a random distribution on the horizontal axis and the dots are within the angular spread of the PAS. In this example, the location corresponding to the peak of the PAS is included in the selected preselection.

Instead of separately determining an error E_{ρ} for each path, it is possible to combine the separate calculations of errors E_{ρ} associated with at least two paths into one combined error operation and have locations for the antenna elements without combinations of separate results of locations of a plurality of paths.

The error E_{ρ} can be used for finding optimized locations for the antenna elements and additionally also a number of antenna elements needed. Hence, instead of having a single predetermined number of random positions for antenna elements in all preselections, the preselector 150 may additionally form at least one preselection with a different predetermined number of positions. In general, the preselector 150 may form a plurality of preselections with various predetermined numbers of locations for antenna elements 102 to 108. For example, a first group of preselections may have NN randomly preselected places for antenna elements. A second group of preselections may have MM randomly preselected places for antenna elements, where NN and MM are different integers larger than 0. In general, there may be KK groups of preselections, where KK is an integer larger than 1. The selector may select a preselection from among preselections with different numbers locations for antenna elements.

The preselector 150 may avoid generation of unrealizable locations. An unrealizable location may be a location which has already been generated in the preselection since two antenna elements cannot be placed in the same location. An unrealizable location may also be a location which would require that two antenna elements lie at least partly inside each other. Hence, the preselector 150 may only allow formation of a preselection where a distance between any two preselected locations is greater than a predetermined distance. Similarly, it can be realized that the preselector 150 may only allow generation of a location which is at or farther than a predetermined minimum distance from any previously generated location. The predetermined minimum distance is a distance between two antenna elements such that the antenna elements have a structural contact with each other.

A realizable location, on the other hand, is one at which the antenna element may have a structural contact with another antenna element without requiring a common space. A realizable location is also such that an outer surface of an antenna element has a non-zero distance to an outer surface of another antenna element which is to be located at any earlier preselected location.

If the minimum distance is measured from outer surfaces of the antenna elements, the predetermined minimum distance is zero. If a location of an antenna element is defined to be a point on a circumference around the DUT 100, where the center of the antenna element is to be aligned with the point, the predetermined minimum distance may mean a length corresponding approximately to the outer physical size of an antenna element.

The location of the first antenna element may be generated freely.

Additionally or alternatively, the selector 152 may ignore each preselection which has at least one unrealizable location during the selection.

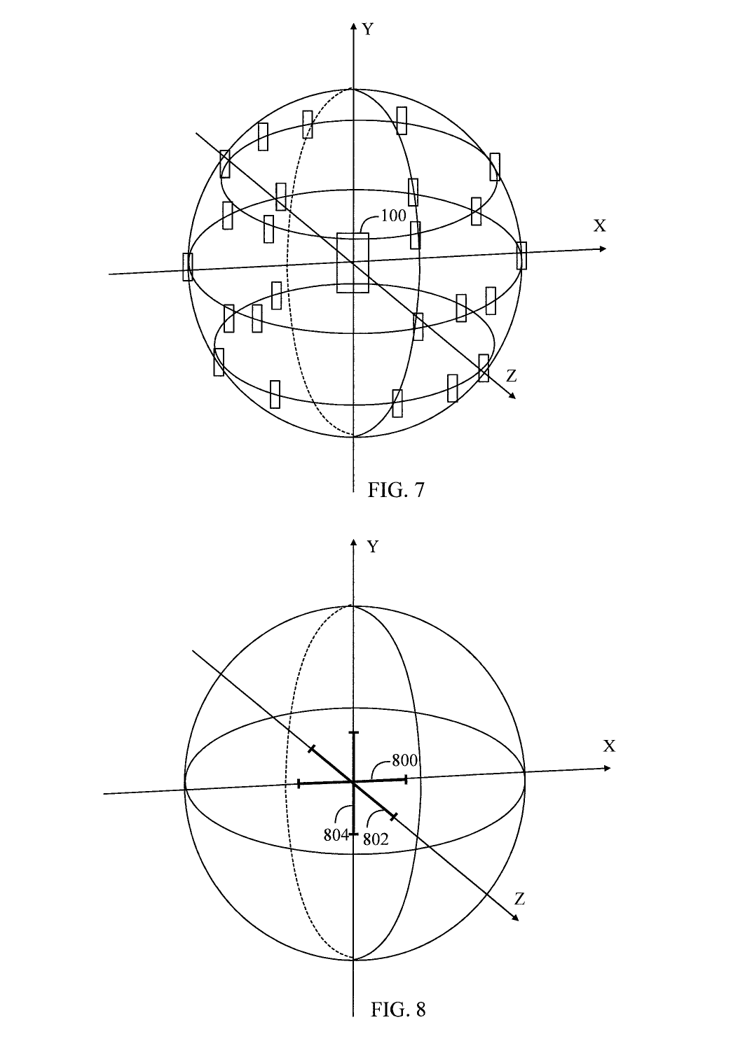

FIG. 7 presents a solid geometrical embodiment of an OTA test chamber. In this example, the antenna elements (rectangles) are placed (as if) on a surface of a sphere while the DUT 100 is in the middle of the sphere. However, the surface on which the antenna elements are (as if) placed may be a part of any surface which encloses a volume. Examples of such surfaces are a surface of a cube, an ellipsoid, a tedraedra, etc.

When antenna elements are placed 3-dimensionally around the DUT 100, the selection of a preselection from a plurality of preselections may be performed in one, two or three orthogonal dimensions. To achieve results in a solid geometry, the spatial correlation and the error E_{ρ} may be calculated along at least three lines having components in all three orthogonal directions.

FIG. 8 presents three lines 800 to 804 for which the spatial correlation may be calculated. The length of the lines corresponds to the diameter of the quiet zone in the test spot 126.

The preselector 150 may select random locations on the surface enclosing at least partly a volume. Like in the plane geometrical embodiment, in a solid geometrical embodiment where the antenna elements 102 to 108 are mounted on an azimuth and elevation planes, there is a plurality of selection algorithms for selecting a preselection from a plurality of preselections.

In an embodiment, the selection of a suitable preselection from a plurality of preselections may be based on the following error function which corresponds to the two-dimensional cost function presented in equation (1):

$${E}_{ρ}^{i} = \sqrt{{\sum }_{n = 1}^{N} {\sum }_{m = 1}^{M} {W}_{n , m} \vert ρ ( {Δ}_{n , m} , {ϕ}_{n} , {σ}_{ϕ} , {γ}_{m} , {σ}_{ϕ} ) - \tilde{ρ} ( {Δ}_{n , m} ) {\vert}^{2}} , \qquad ( 9 )$$

where i refers to an i^{th} preselection, W_{n,m} is an importance weight, i.e. the cost in azimuth (n) and elevation (m) directions, ρ(Δ_{n,m}, φₙ, σ_{φ}, γₘ, σ_{φ}) is a theoretical patial cross correlation on a two-dimensional spatial separation Δ_{n,m} of antenna elements, φₙ is a nominal angle of arrival in azimuth direction, γₘ is a nominal angle of arrival in elevation direction, σ_{φ} is an angular spread in azimuth direction, σ_{γ} is an angular spread in elevation direction, and \tilde{ρ}(Δ_{n,m}) is a real spatial correlation obtained with the OTA antenna elements. The selection of a preselection from the plurality of preselections on the basis of equation (9) and may be performed for the three orthogonal segments of lines 800 to 804 presented in FIG. 8.

A preselection determining locations of antenna elements may be selected from the plurality of preselections may be based on finding an optimized error E_{ρ} in similar manner to that of the two-dimensional embodiments.

The present solution may be applied to a MIMO system, too. The channel model for a MIMO OTA is a geometric antenna independent. When solid geometry in concerned, the parameters of a radio channel may be as follows:
power (P), delay (τ),
azimuth angle of arrival (AoA), angle spread of arrival azimuth angles (ASA), shape of clusters (PAS),
azimuth angle of departure (AoD), angle spread of departure azimuth (ASD), shape of PAS,
elevation angle of arrival (EoA), angle spread of arrival elevation angles (ESA), shape of PAS,
azimuth angle of departure (EoD), angle spread of departure elevation angles (ESD), shape of PAS,
cross polarization power ratio (XPR).
   The parameters may be used in the optimization algorithm.

One of the challenges in a MIMO OTA system is to model an arbitrary power angular spectrum (PAS) with a limited number of OTA antennas. The modeling may be performed (assuming uncorrelated scattering) by transmitting independent fading signals from different OTA antennas with antenna specific power weights gₖ in a manner similar to that described above. A continuous PAS may be modeled by a discrete PAS using discrete OTA antenna elements at randomly chosen but optimally selected directions θₖ.

OTA antenna parameters can be resolved by an error function which is similar to what is presented above. The error function for determination of OTA antenna locations may be expressed as:

$${E}_{ρ}^{i} = \sqrt{\frac{1}{M} {\sum }_{m = 1}^{M} \vert ρ ( {P}_{ϕ} , {Δ}_{m} ) - \tilde{ρ} ( Θ , G , {Δ}_{m} ) {\vert}^{2}} \qquad ( 10 )$$

where Θ={θₖ}, θₖ ∈ [0,2π] is a vector of OTA antenna element direction, G ={gₖ}, gₖ ∈ [0,1] is a vector of an OTA antenna element power weight, ρ(P_{φ}, Δₘ) is a theoretical spatial correlation, \tilde{ρ}(Θ, G, Δₘ) is a spatial correlation obtained with parameters Θ and G by the antenna elements, P_{φ} is power angular spectrum with a known shape (e.g. Laplacian), nominal angle of arrival φ₀, and rms angular spread σ₁₀₀.

The spatial correlation \tilde{ρ}(Θ, G, Δₘ) obtained with OTA antennas may be defined as:

$$\tilde{ρ} ( Θ , G , {Δ}_{m} ) = {( {\sum }_{k = 1}^{{K}^{′}} {g}_{k} )}^{- 1} {\sum }_{k = 1}^{{K}^{′}} {g}_{k} exp ( - j 2 {πΔ}_{m} sin {θ}_{k} ) , \qquad ( 11 )$$

where weights G, gₖ are defined by the PAS.

Finally, the locations of the OTA antenna power elements defined by θₖ may be obtained by searching for a minimum of the error E_{ρ}:

{θ₁, θ₂, . . . , θ_{K}}=min(E_{ρ}¹, E_{ρ}², . . . , E_{ρ}^{K}) (12)

Instead of the minimum, a suitable optimum of the error E_{ρ} may be seached for.

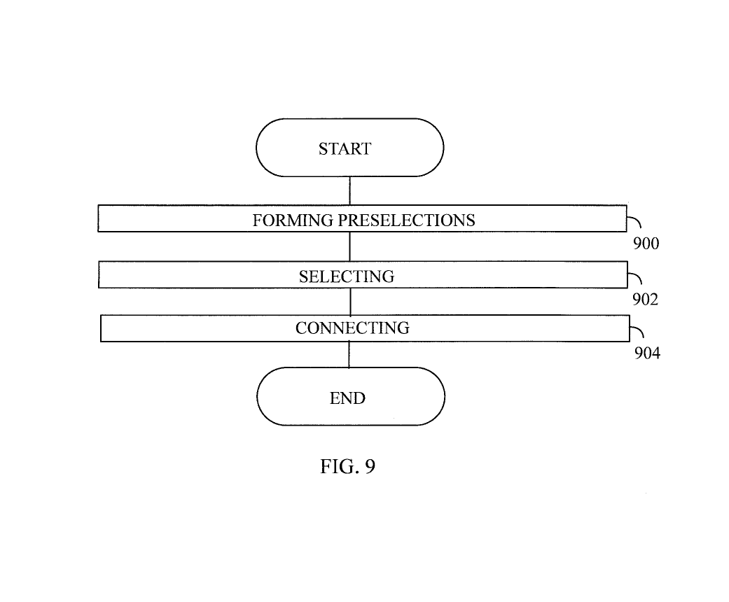

FIG. 9 presents a flow chart of the method. In step 900, a plurality of preselections are formed for each preselection by generating a predetermined number of random locations, each location being for an antenna element of the predetermined number of antenna elements around the device under test in an over-the-air test. In step 902, a preselection is selected for at least one path of a simulated radio channel from among the plurality of preselections for which an absolute error between a theoretical and real spatial correlation is below a predetermined threshold. In step 904, the antenna elements at the locations of the selected preselection of the at least one path and the radio channel emulator are connected together for physically realizing the simulated radio channel for the device under test and the radio channel emulator.

The emulator 148, the preselector 150 and/or the selector 152 may generally include a processor, connected to a memory. The preselector 150 and selector 152 may be integrated into a single device or they may be separate. Generally the processor is a central processing unit, but the processor may also be an additional operation processor. The processor may comprise a computer processor, ASIC (Application-Specific Integrated Circuit), FPGA (Field-Programmable Gate Array), and/or other hardware components that have been programmed to carry out one or more functions of an embodiment.

The memory may include volatile and/or non-volatile memory and it typically stores data. For example, the memory may store a computer program code such as software applications or operating systems, information, data, content for the processor to perform steps associated with operation of the apparatus in accordance with embodiments. The memory may be, for example, RAM (Random Access Memory), a hard drive, or other fixed data memory or storage device. Further, the memory, or part of it, may be removable memory detachably connected to the emulating system.

The techniques described herein may be implemented by various means. For example, these techniques may be implemented in hardware, firmware, software, or combinations thereof. For firmware or software, implementation can be through modules that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

The embodiments may be applied in 3GPP (Third Generation Partnership Project) LTE (Long Term Evolution), WiMAX (Worldwide Interoperability for Microwave Access), Wi-Fi and/or WCDMA (Wide-band Code Division Multiple Access). The MIMO is also a possible field of application.

It will be obvious to a person skilled in the art that, as technology advances, the inventive concept can be implemented in various ways. The invention and its embodiments are not limited to the examples described above but may vary within the scope of the claims.

1. An apparatus comprising
a preselector configured to form a plurality of preselections, by generating, for each preselection, a predetermined number of random locations, each location being for an antenna element of the predetermined number of antenna elements around a device under test in an over-the-air test;
a selector configured to select, for at least one path of a radio channel to be simulated, a preselection from among the plurality of preselections for which an absolute error between a theoretical and real spatial correlation is below a predetermined threshold; and
a connector configured to connect the antenna elements at the locations of the selected preselection and a radio channel emulator together for physically realizing the simulated radio channel for the device under test and the radio channel emulator.

2. The apparatus of claim 1, wherein the preselector is configured to form preselections with a plurality of different numbers of locations for antenna elements, and the selector is configured to select a preselection from among preselections with the different numbers of locations for antenna elements.

3. The apparatus of claim 1, wherein the selector is configured to select a desired preselection from among the plurality of random preselections for which a value of an error function based on a theoretical and real spatial correlation is optimized.

4. The apparatus of claim 1, wherein the apparatus is configured to avoid generation of unrealizable locations.

5. The apparatus of claim 1, wherein the selector is configured to ignore each preselection with at least one unrealizable location during the selection.

6. The apparatus of claim 1, wherein the preselector is configured to only allow formation of a preselection having a distance between any two locations greater than a predetermined minimum distance, a first location in the preselection being freely generated.

7. The apparatus of claim 1, wherein the preselector is configured to only allow generation of a location which is farther than a predetermined minimum distance from each previously generated location, the first location in each preselection being freely generated.

8. The apparatus of claim 6, wherein the predetermined minimum distance is a distance between two antenna elements having a structural contact with each other.

9. A method comprising
forming a plurality of preselections, by generating, for each preselection, a predetermined number of random locations, each location being for an antenna element of the predetermined number of antenna elements around a device under test in an over-the-air test;
selecting, for at least one path of a simulated radio channel, a preselection from among the plurality of a preselections for which an absolute error between a theoretical and real spatial correlation is below a predetermined threshold; and
connecting the antenna elements at the locations of the selected preselection of the at least one path and a radio channel emulator together for physically realizing the simulated radio channel for the device under test and the radio channel emulator.

10. The method of claim 9, the method further comprising forming preselections with a plurality of different predetermined numbers of locations for antenna elements, and selecting a preselection from among preselections with the different predetermined numbers of locations for antenna elements.

11. The method of claim 9, the method further comprising selecting a preselection from among the plurality of random preselections for which a value of an error function based on a theoretical and real spatial correlation is optimized.

12. The method of claim 9, the method further comprising preventing generation of unrealizable locations.

13. The method of claim 9, the method further comprising ignoring each preselection with at least one unrealizable location during the selection.

14. The method of claim 12, the method further comprising allowing only formation of a preselection if a distance between any two locations in the preselection is greater than a predetermined minimum distance, a first location in the preselection being freely generated.

15. The method of claim 12, the method further comprising allowing only generation of a location which is farther than a predetermined minimum distance from any previously generated location, the first location in each preselection being freely generated.

16. The method of claim 14, wherein the predetermined minimum distance is a distance between two antenna elements having a structural contact with each other.

17. An emulating system of an over-the-air test, the emulating system comprising a radio channel emulator, a plurality of antenna elements, a preselector, a selector, and a connector;
the preselector being configured to form a plurality of preselections, by generating, for each preselection, a predetermined number of random locations, each location being for an antenna element of the predetermined number of antenna elements around a device under test in an over-the-air test;
the selector being configured to select, for at least one path of a radio channel to be simulated, a preselection from among the plurality of preselections for which an absolute error between a theoretical and real spatial correlation is below a predetermined threshold;
the connector being configured to connect the antenna elements at the locations of the selected preselection and the radio channel emulator together for physically realizing the simulated radio channel for the device under test and the radio channel emulator.

18. The apparatus of claim 7, wherein the predetermined minimum distance is a distance between two antenna elements having a structural contact with each other.

19. The method of claim 15, wherein the predetermined minimum distance is a distance between two antenna elements having a structural contact with each other.
